(19) United States
(12) Patent Application Publication
(10) Pub. No.: US 2024/0345344 A1
(43) Pub. Date: Oct. 17, 2024

(54) OPTICALLY INTERCONNECTED HIGH BANDWIDTH MEMORY ARCHITECTURES

(71) Applicants: Sunghwan Min, Sunnyvale, CA (US); Bardia Pezeshki, Sunnyvale, CA (US); Robert Kalman, Sunnyvale, CA (US); Emad Afifi, Sunnyvale, CA (US)

(72) Inventors: Sunghwan Min, Sunnyvale, CA (US); Bardia Pezeshki, Sunnyvale, CA (US); Robert Kalman, Sunnyvale, CA (US); Emad Afifi, Sunnyvale, CA (US)

(21) Appl. No.: 18/633,122

(22) Filed: Apr. 11, 2024

Related U.S. Application Data
(60) Provisional application No. 63/458,598, filed on Apr. 11, 2023.

(51) Int. Cl. G02B 6/42

(52) U.S. Cl. CPC G02B 6/4274; G02B 6/4202; G02B 6/4214; G02B 6/4243

(57) ABSTRACT

A System-on-Chip (SoC) may be optically interconnected with memory. The SoC and a first electronic and photonic IC chip may be housed in a same semiconductor package. The first electronic and photonic IC chip may be in optical communication with a second electronic and photonic IC chip in electrical communication with memory. The first and second electronic and photonic IC chips may include microLEDs and photodetectors, for example bonded to surfaces of the first and second photonic IC chips. The optical communication may be through a transmission medium, which may be optical fibers. The optical fibers may be in one or more fiber bundles.

### CROSS-REFERENCE TO RELATED APPLICATIONS

This application claims the benefit of U.S. Provisional Patent Application No. 63/458,598, filed on Apr. 11, 2023, the disclosure of which is incorporated by reference herein.

### BACKGROUND OF THE INVENTION

Limited interconnect bandwidth between high-performance ICs and memory has a significant impact on system processing performance. Currently, the highest bandwidth memory interconnect is for High Bandwidth Memory (HBM). HBM uses vertically stacked memory die with through-silicon vias (TSVs) to maximize memory capacity within a very limited interconnect distance.

To achieve this very high bandwidth with high IC shoreline density and low power dissipation, a large system-on-a-chip (SoC) 111 and HBM stack 113 are interconnected via a silicon interposer 115 within a multi-chip package, as illustrated in (FIG. 1). A memory controller 121 is within the SoC, for controlling communications with the HBM stack. AThe die-to-die (D2D) interconnect between the SoC and the HBM stack is provided by a physical layer device (PHY) 119a,b on each of the SoC and the HBM stack connected by a 1024-bit wide bus that is limited to a maximum length of just a few millimeters. This means that the maximum HBM memory capacity accessible by an SoC is limited by the SoC shoreline length and the number of HBM dies that can be stacked. This also requires the HBM to be very close to a hot SoC, which degrades performance of the HBM DRAM due to the need for a relatively high refresh frequency.

The ability to implement much longer (centimeters to meters) HBM interconnects would provide a number of benefits, which may include making much more HBM capacity accessible to an SoC, physically separating the HBM from a hot SoC (potentially allowing the HBM to be run at lower temperature, increasing its performance), and, with appropriate architectures, a given HBM stack can be accessed by multiple SoCs.

### BRIEF SUMMARY OF THE INVENTION

In some embodiments of an optically interconnected HBM, a first multi-chip package (MCP) that comprises an SoC and an optical interface is interconnected to a second MCP that comprises one or more HBMs and an optical interface, where the two MCPs are interconnected by an optical transmission medium. The optical interfaces on the two MCPs connected by the optical transmission medium comprise an optical interconnect, in some cases a duplex optical interconnect.

In some embodiments, each direction of a duplex parallel optical interconnect comprises an array of optical emitters, input coupling optics, a transmission medium, output coupling optics, and an array of photodetectors (PDs). In some embodiments, there are no input and output coupling optics, and the emitter and PD arrays are butt-coupled to the transmission medium.

In some embodiments, the array of emitters and the array of PDs are located on some regular grid. In some embodiments, the emitter and PD grids are hexagonal close-packed (HCP), square, or rectangular grids. In some embodiments, the center-to-center spacing of grid elements are in the range of 20 um-100 um.

In some embodiments of a parallel optical interconnect, the transmission medium comprises an array of optical fibers (a fiber “bundle”) or an array of optical waveguides. A FOB comprises multiple fiber elements (FEs). Each FE comprises a core surrounded by a concentric cladding layer with a lower index of refraction than the core, enabling the guiding of light in the core. In some embodiments, all FEs have the same nominal dimensions and properties.

In some embodiments, the first MCP comprises a silicon interposer that interconnects a SoC and an electronic and photonic IC (EPIC) via a die-to-die (D2D) interface (FIG. 5). In some embodiments, an EPIC comprises an array of optical emitters, an array of PDs, and an IC, where the IC comprises transmitter electronics, receiver electronics, and other logic electronics. In some embodiments, the array of emitters comprises an array of GaN microLEDs that are bonded to pads on the IC, for instance using solder bonding or metal-metal bonding. In some embodiments, the array of PDs is monolithically integrated into the IC. In some embodiments, the array of PDs comprises PDs on a separate substrate that are bonded to pads on the IC, for instance using solder bonding or metal-metal bonding.

In some embodiments, the second MCP comprises an EPIC connected to an HBM stack via a D2D interconnect over a passive silicon interposer, where the EPIC comprises the HBM memory controller (MC). In some embodiments, the second MCP comprises an active silicon interposer that supports a D2D interconnect between an EPIC and an HBM stack, where the interposer comprises the HBM MC. In some embodiments, the second MCP comprises an EPIC to which an HBM stack is mounted, where the EPIC comprises the HBM MC. In some embodiments, the second MCP comprises an EPIC to which an HBM stack is mounted, where the buffer die of the HBM stack comprises the HBM MC.

Some aspects of the invention provide a device including an optically connected high bandwidth memory, comprising: a first multi-chip package comprising a system-on-chip (SoC) and a first electronic and photonic integrated circuit chip on a first substrate, the SoC and the first electronic and photonic integrated circuit chip housed in a semiconductor package of the first multi-chip package, the first substrate including electrical pathways for electrical communication between the SoC and the first electronic and photonic circuit chip, the first electronic and photonic integrated circuit chip having a surface with an array of microLEDs and an array of photodetectors bonded thereto; a second multi-chip package comprising a high bandwidth memory, a second electronic and photonic integrated circuit chip, and a memory controller, the high bandwidth and the second electronic and photonic integrated circuit chip housed in a semiconductor package of the second multi-chip package, the second electronic and photonic integrated circuit chip having a surface with an array of microLEDs and an array of photodetectors bonded thereto; and an optical transmission medium coupling the first electronic and photonic integrated circuit chip and the second electronic and photonic integrated circuit chip.

In some aspects the memory controller is part of the second electronic and photonic integrated circuit chip. In some aspects the second electronic and photonic integrated circuit chip and the high bandwidth memory are on a common substrate. In some aspects the common substrate is a silicon interposer. In some aspects the silicon interposer includes electrical signal pathways allowing for communication between the second electronic and photonic integrated circuit chip and the high bandwidth memory. In some aspects each of the second electronic and photonic integrated circuit chip and a buffer chip of the high bandwidth memory include die-to-die interface circuitry for communicating with each other over the electrical signal pathways of the silicon interposer. In some aspects the optical transmission medium comprises at least one optical fiber bundle. In some aspects the high bandwidth memory is on the second electronic and photonic integrated circuit chip. In some aspects the memory controller is part of buffer chip of the high bandwidth memory, and the high bandwidth memory is on the second electronic and photonic integrated circuit chip. In some aspects the second electronic and photonic integrated circuit chip are on an active silicon interposer. In some aspects the memory controller is part of the active silicon interposer.

These and other aspects of the invention are more thoroughly comprehended upon review of this disclosure.

### BRIEF DESCRIPTION OF THE FIGURES

FIG. 1 is a semi-block diagram of a system-on-chip (SoC) and high-bandwidth memory (HBM) stack on an interposer.

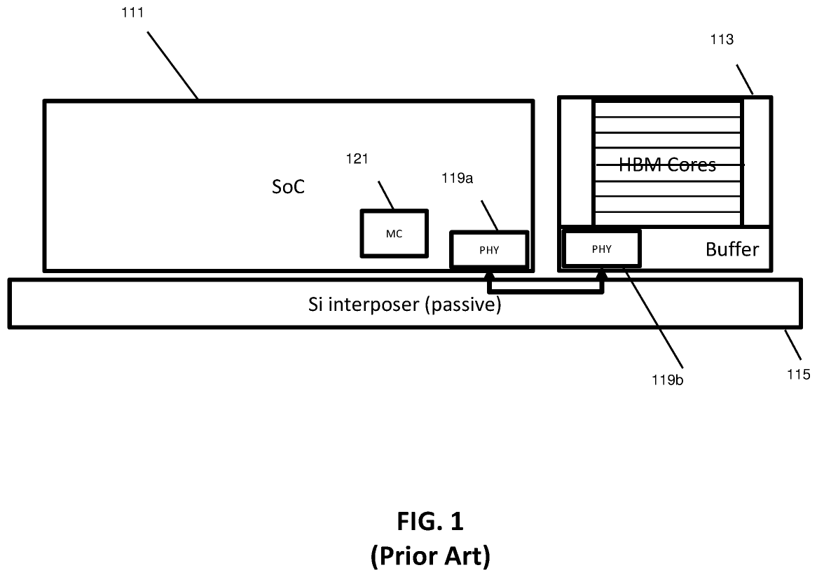

FIG. 2 is a semi-block diagram of a pair of multi-chip packages coupled by an optical transmission medium, in accordance with aspects of the invention.

FIG. 3 illustrates an example optical coupling between a microLED array and a photodetector array, in accordance with aspects of the invention.

FIG. 4 illustrates elements of an example electronic and photonic IC or optical transceiver chip, in pseudo-cross-sectional form, in accordance with aspects of the invention.

FIG. 5 is a semi-block diagram of a multi-chip package including an SoC and an electronic and photonic IC chip, in accordance with aspects of the invention.

FIGS. 6A-D are semi-block diagrams of arrangements with a photonic and electronic IC in communication with high-bandwidth memory (HBM), in accordance with aspects of the invention.

### DETAILED DESCRIPTION

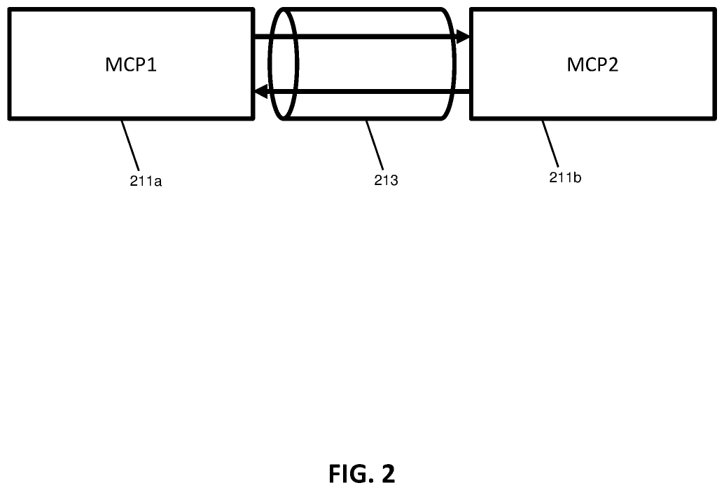

FIG. 2 is a semi-block diagram of a pair of multi-chip packages coupled by an optical transmission medium. In FIG. 2, a first multichip package 211a is coupled to an optical transmission medium 213. A second multichip package 211b is also coupled to the optical transmission medium.

The first multichip package may house a system-on-chip (SoC) and a first optical interface. The SoC may be mounted to an interposer within the multichip package, or a package substrate of the multichip package. The first multichip package also includes a first electronic and photonic IC, which may be in the form of a so-called chiplet. The first electronic and photonic IC may be considered a first optical transceiver chip, considering the elements of the photonic IC. The first optical transceiver chip provides the optical interface, or at least part of it. The first optical transceiver chip is also mounted to the interposer or the package substrate. Electrical communication pathways of the interposer or package substrate electrically couple the SoC and the first optical transceiver chip, allowing for data communication between the two.

The first multichip package is coupled to the optical transmission medium 213, at a first end of the optical transmission medium. In some embodiments the first optical interface is coupled to the optical transmission medium. In some embodiments the first optical transceiver chip is coupled to the optical transmission medium. In some embodiments the first optical transceiver chip includes microLEDs and photodetectors, with for example the microLEDs and photodetectors bonded to the first optical transceiver chip. In some embodiments the microLEDs and photodetectors of the first optical transceiver chip are optically coupled to the optical transmission medium. In some embodiments the microLEDs are arranged in a first microLED array and the photodetectors are arranged in a first photodetector array.

In some embodiments the optical transmission medium is comprised of optical fibers. In some embodiments the optical fibers are arranged in a fiber bundle. In some embodiments the fiber bundle is a coherent fiber bundle, with fibers of the fiber bundle having the same relative arrangement to one another at each end of the fiber bundle. In some embodiments the fiber bundle contains a plurality of fiber sub-bundles. In some embodiments each of the fiber sub-bundles is coherent, but the fiber bundle as a whole is not coherent. In some embodiments the optical transmission medium comprises a plurality of fiber bundles.

The second multichip package is coupled to the optical transmission medium, at a second end of the optical transmission medium. The second multichip package may house memory and a second optical interface. In some embodiments the memory is high bandwidth memory (HBM). The memory may be mounted to an interposer within the multichip package, or a package substrate of the multichip package. The second multichip package also includes a second optical transceiver chip, which may be in the form of a so-called chiplet. The second optical transceiver chip provides the optical interface, or at least part of it. The second optical transceiver chip is also mounted to the interposer or the package substrate. Electrical communication pathways of the interposer or package substrate electrically couple the memory and the second optical transceiver chip, allowing for data communication between the two. In some embodiments the memory may be mounted to the second optical transceiver chip instead of to the interposer or package substrate.

In some embodiments the second optical interface is coupled to the optical transmission medium. In some embodiments the second optical transceiver chip is coupled to the optical transmission medium. In some embodiments the second optical transceiver chip includes microLEDs and photodetectors, with for example the microLEDs and photodetectors bonded to the second optical transceiver chip. In some embodiments the microLEDs and photodetectors of the second optical transceiver chip are optically coupled to the optical transmission medium. In some embodiments the microLEDs are arranged in a second microLED array and the photodetectors are arranged in a second photodetector array. In some embodiments the optical transmission medium couples the first microLED array of the first optical transceiver chip with the second photodetector array of the second optical transceiver chip. In some embodiments a first fiber bundle couples the first microLED array of the first optical transceiver chip with the second photodetector array of the second optical transceiver chip. In some embodiments the optical transmission medium couples the second microLED array of the second optical transceiver chip with the first photodetector array of the first optical transceiver chip. In some embodiments a second fiber bundle couples the second microLED array of the second optical transceiver chip with the first photodetector array of the first optical transceiver chip.

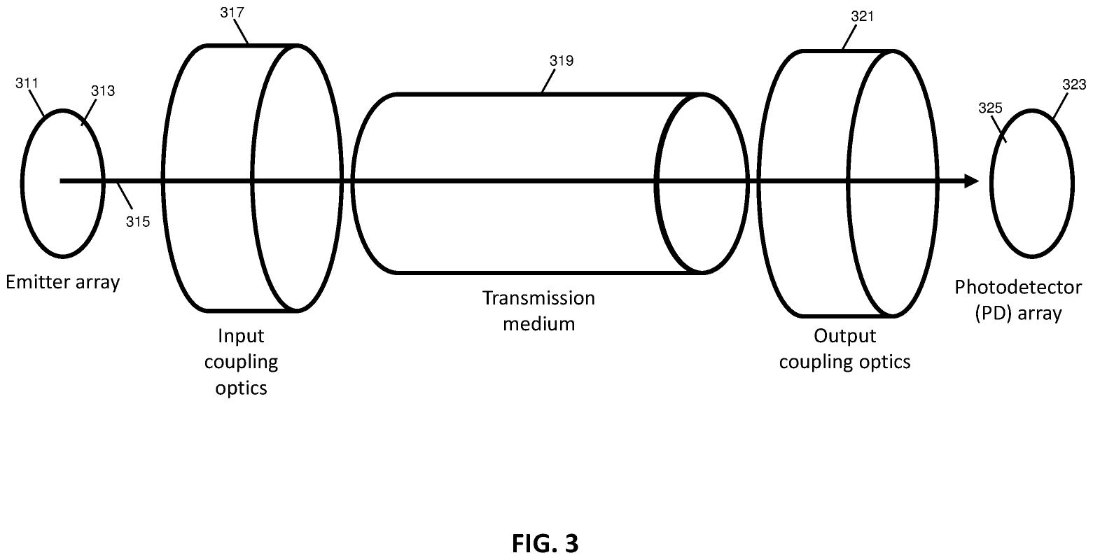

FIG. 3 illustrates an example optical coupling between a microLED array and a photodetector array. In some embodiments the example of FIG. 3 may be considered one direction of a bi-directional duplex parallel optical interconnect. A corresponding parallel reverse-direction example (not shown in FIG. 3) providing the other direction of the bi-directional duplex parallel optical interconnect.

In FIG. 3, an emitter array 311 includes a plurality of microLEDs, for example microLED 313. The microLEDs can be considered an array of microLEDs. In FIG. 3, the plurality of microLEDs are shown as arranged to fill a circular area. In some embodiments the microLEDs may fill a hexagonal area, a rectangular area, or some other area. In some embodiments, the microLEDs are arranged in a grid. In some embodiments the grid is a hexagonal close-packed (HCP) grid, a square grid, or a rectangular grid. In some embodiments, the center-to-center spacing of grid elements are in the range of 20 um-100 um.

Input coupling optics 317 couples light 315 from the emitter array with a transmission medium 319. In some embodiments the input coupling optics may be omitted. For example, in some embodiments the transmission medium may be butt-coupled to the emitter array instead. In some embodiments the input coupling optics comprises one or more lenses and/or one or more mirrors. In some embodiments there is a lens for each microLED in the array of microLEDs. In some embodiments there is a single lens for all of the microLEDs in the array of microLEDs. In some embodiments there is a pair of lenses for all of the microLEDs in the array of microLEDs, for example with a lens on either side of a turning mirror of the input coupling optics. In some embodiments there is a lens for each microLED in the array of microLEDs between the microLEDs and a turning mirror, and a single lens between the turning mirror and the transmission medium. In some embodiments the optical transmission medium 319 comprises optical fibers. In

some embodiments the optical fibers are arranged in a fiber bundle. In some embodiments the fiber bundle is a coherent fiber bundle, with fibers of the fiber bundle having the same relative arrangement to one another at each end of the fiber bundle. In some embodiments the fiber bundle contains a plurality of fiber sub-bundles. In some embodiments each of the fiber sub-bundles is coherent, but the fiber bundle as a whole is not coherent. In some embodiments the optical transmission medium comprises a plurality of fiber bundles. In some embodiments light from each microLED of the microLED array is carried by a single fiber. In some embodiments light from each microLED is carried by a plurality of fibers.

In FIG. 3, light from the microLEDs passed through the optical transmission medium is coupled to a plurality of photodetectors by optional output coupling optics 321. The photodetectors may be considered an array of photodetectors. The output coupling optics, like the input coupling optics, may comprise comprises one or more lenses and/or one or more mirrors. In some embodiments there is a lens for each photodetector in the array of photodetectors. In some embodiments there is a single lens for all of the photodetectors in the array of photodetectors. In some embodiments there is a pair of lenses for all of the photodetectors in the array of photodetectors, for example with a lens on either side of a turning mirror of the input coupling optics. In some embodiments there is a lens for each photodetector in the array of photodetectors between the photodetectors and a turning mirror, and a single lens between the turning mirror and the transmission medium.

In FIG. 3, the plurality of photodetectors are shown as arranged to fill a circular area. In some embodiments the photodetectors may fill a hexagonal area, a rectangular area, or some other area. In some embodiments, the photodetectors are arranged in a grid. In some embodiments the grid is a hexagonal close-packed (HCP) grid, a square grid, or a rectangular grid. In some embodiments, the center-to-center spacing of grid elements are in the range of 20 um-100 um. In some embodiments there is a one-to-one correspondence between photodetectors and microLEDs.

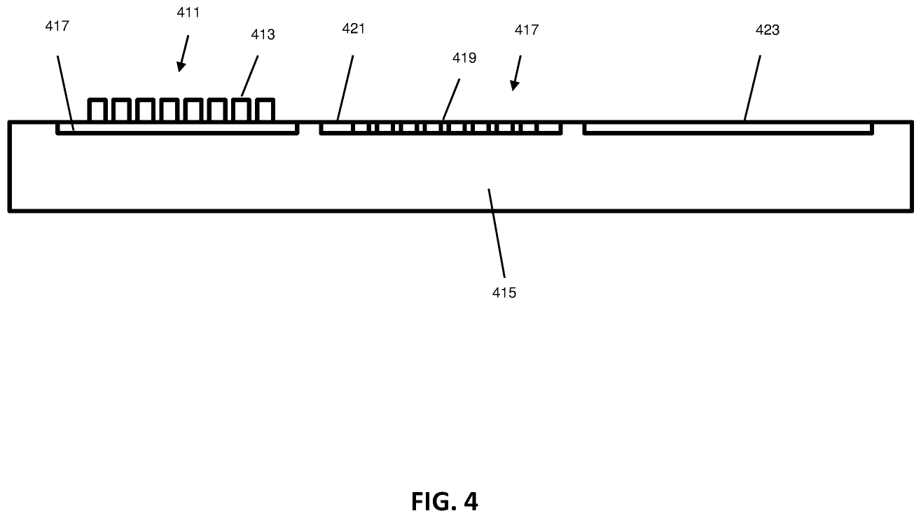

FIG. 4 illustrates elements of an example electronic and photonic IC or optical transceiver chip, in pseudo-cross-sectional form. The chip includes a silicon substrate 415. MicroLEDs 411, including for example microLED 413, are on a surface of the silicon substrate. The microLEDs may be GaN microLEDs. The microLEDs may be bonded to the surface of the silicon substrate, for example pads of the silicon substrate. The bonding may be, for example, solder bonding or metal-metal bonding. The microLEDs may be directly bonded to the silicon substrate in some embodiments, or more commonly the microLEDs may be on a layer (or multiple layers) bonded to the silicon substrate. The microLEDs may be arranged together in an array, for example.

The silicon substrate includes an active layer for circuitry. The active layer is generally close to the side of the silicon substrate to which the microLEDs are bonded. Generally, through-silicon-vias (TSVs) (not shown in FIG. 4) couple the active layer and electrical pads (also not shown in FIG. 4) on a side of the silicon substrate opposite the side to which the microLEDs are bonded. In the active layer, transmission circuitry 417 for driving the microLEDs in shown as being under the microLEDs. Photodetectors 417, for example photodetector 419, are also shown as being in the active layer, although in some embodiments they may be bonded to the silicon substrate, the same as or similar to the microLEDs. The photodetectors may also be arranged in an array, for example. Receive circuitry 421, for example including transimpedance amplifiers (TIAs) and other receive circuitry, are also in the active layer, about the photodetectors. The active layer may also include logic circuitry 423.

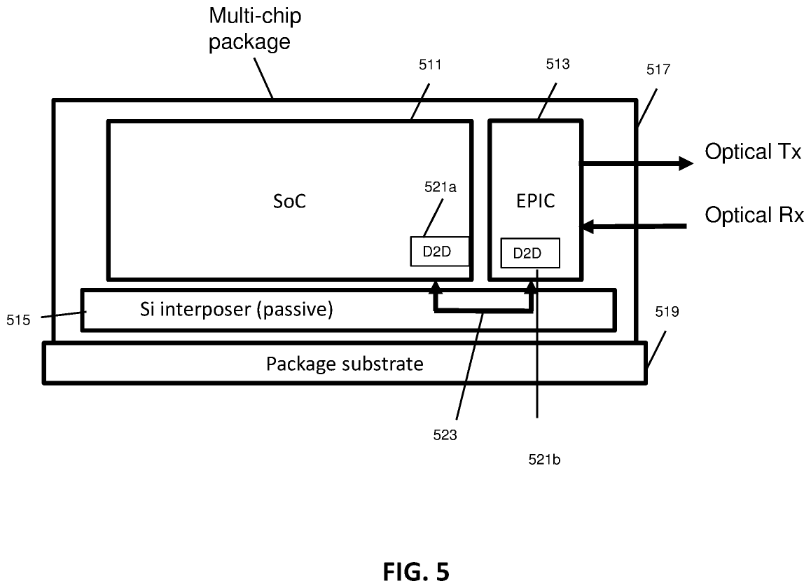

FIG. 5 is a semi-block diagram of a multi-chip package including an SoC and an electronic and photonic IC chip. The SoC 511 and the electronic and photonic IC chip 513, or optical transceiver chip, are both on a silicon interposer 515. The silicon interposer is on a package substrate 519 of the multi-chip package 517. All of the SoC, optical transceiver chip, and interposer are housed within the multichip package. The electronic and photonic IC chip 513 may be as discussed and/or shown herein. The electronic and photonic IC chip may include, for example, a silicon substrate having an active layer with transmit circuitry and receive circuitry, and possibly other logic, MicroLEDs and photodetectors bonded to the silicon substrate and coupled to the transmit and receive circuitry, respectively.

The SoC is in electrical data communication with the electronic and photonic IC by way of electrical pathways on the silicon interposer. In some embodiments the electrical pathways may form pathways of a bus. In some embodiments the bus may be a 1024-bit wide bus. To this end, each of the SoC and the electronic and photonic IC chip may include a die-to-die interface 521a,b, respectively, for communicating with each other.

The electronic and photonic IC optically communicates outside the multi-chip package by way of one or more optical couplings, for example by way of elements of the optical coupling of FIG. 3. In some embodiments the optical couplings include a transmit direction optical coupling and a receive direction optical coupling.

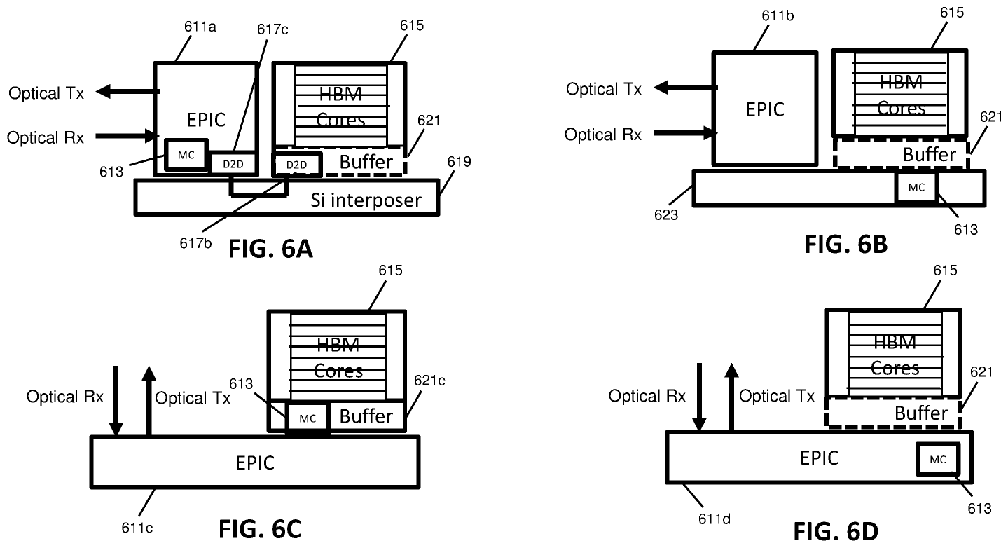

FIGS. 6A-D are semi-block diagrams of arrangements with a photonic and electronic IC in communication with high-bandwidth memory (HBM). FIG. 6A shows an electronic and photonic IC chip 611a and high-bandwidth memory 615 on and communicating through a silicon interposer 619, with a memory controller 613 in the electronic and photonic IC chip. the electronic photonic chip.

In some embodiments, the second MCP comprises an EPIC connected to an HBM stack via a D2D interconnect over a passive silicon interposer, where the EPIC comprises the HBM memory controller (MC). In some embodiments, the second MCP comprises an active silicon interposer that supports a D2D interconnect between an EPIC and an HBM stack, where the interposer comprises the HBM MC. In some embodiments, the second MCP comprises an EPIC to which an HBM stack is mounted, where the EPIC comprises the HBM MC. In some embodiments, the second MCP comprises an EPIC to which an HBM stack is mounted, where the buffer die of the HBM stack comprises the HBM MC.

Although the invention has been discussed with respect to various embodiments, it should be recognized that the invention comprises the novel and non-obvious claims supported by this disclosure.

What is claimed is:

1. A device including an optically connected high bandwidth memory, comprising:
a first multi-chip package comprising a system-on-chip (SoC) and a first electronic and photonic integrated circuit chip on a first substrate, the SoC and the first electronic and photonic integrated circuit chip housed in a semiconductor package of the first multi-chip package, the first substrate including electrical pathways for electrical communication between the SoC and the first electronic and photonic circuit chip, the first electronic and photonic integrated circuit chip having a surface with an array of microLEDs and an array of photodetectors bonded thereto;
a second multi-chip package comprising a high bandwidth memory, a second electronic and photonic integrated circuit chip, and a memory controller, the high bandwidth and the second electronic and photonic integrated circuit chip housed in a semiconductor package of the second multi-chip package, the second electronic and photonic integrated circuit chip having a surface with an array of microLEDs and an array of photodetectors bonded thereto; and
an optical transmission medium coupling the first electronic and photonic integrated circuit chip and the second electronic and photonic integrated circuit chip.

2. The device of claim 1, wherein the memory controller is part of the second electronic and photonic integrated circuit chip.

3. The device of claim 2, wherein the second electronic and photonic integrated circuit chip and the high bandwidth memory are on a common substrate.

4. The device of claim 3, wherein the common substrate is a silicon interposer.

5. The device of claim 4, wherein the silicon interposer includes electrical signal pathways allowing for communication between the second electronic and photonic integrated circuit chip and the high bandwidth memory.

6. The device of claim 5, wherein each of the second electronic and photonic integrated circuit chip and a buffer chip of the high bandwidth memory include die-to-die interface circuitry for communicating with each other over the electrical signal pathways of the silicon interposer.

7. The device of claim 3, wherein the optical transmission medium comprises at least one optical fiber bundle.

8. The device of claim 2, wherein the high bandwidth memory is on the second electronic and photonic integrated circuit chip.

9. The device of claim 1, wherein the memory controller is part of buffer chip of the high bandwidth memory, and the high bandwidth memory is on the second electronic and photonic integrated circuit chip.

10. The device of claim 1, wherein the second electronic and photonic integrated circuit chip are on an active silicon interposer.

11. The device of claim 10, wherein the memory controller is part of the active silicon interposer.
